(19) United States
(12) Patent Application Publication
(10) Pub. No.: US 2015/0381969 A1
(43) Pub. Date: Dec. 31, 2015

(54) SYSTEM FOR SIMULTANEOUSLY DISPLAYING MULTIPLE MULTIMEDIA STREAMS, INCLUDING MULTIPLE VIEWING SPECTACLES AND A DISPLAYING MEDIUM

(71) Applicants: INSTITUT MINES TELECOM, Brest (FR); EYES TRIPLE SHUT, Paris (FR)

(72) Inventors: Jean-Louis De Bougrenet de la Tocnaye, Guilers (FR); Emmanuel Daniel, Le Relecq-Kerhuon (FR); Laurent Dupont, Plouzane (FR); Daniel Stoenescu, Brest (FR); Frederic Lucarz, Brest (FR)

(73) Assignees: INSTITUT MINES TELECOM, Brest (FR); EYES TRIPLE SHUT, Paris (FR)

(21) Appl. No.: 14/765,476

(22) PCT Filed: Feb. 3, 2014
(86) PCT No.: PCT/EP2014/052067

§ 371 Date: Aug. 3, 2015

(30) Foreign Application Priority Data
Feb. 1, 2013 (FR) 1350895

(51) Int. Cl. H04N 13/04; G02B 27/01; H04N 13/00

(52) U.S. Cl. CPC H04N 13/044; H04N 13/0431; H04N 13/0434; H04N 13/0438; H04N 13/0497; H04N 13/0059; G02B 27/0172

(57) ABSTRACT

A system for displaying N multimedia streams, including multiple pairs of viewing spectacles and a displaying medium. The system obtains N multimedia streams, each stream including two multimedia substreams among 2×N multimedia substreams, and has N sources generating the 2×N substreams on the displaying medium. Each source has an encoder for coding two of the 2×N multimedia substreams, each substream being coded with a set of N coding modes each using a specific set of at least two states, having at least 2^{N} possible combinations of states, each substream being coded with one of the possible combinations of states in order to visualize a given stream from the N multimedia stream. At least one pair spectacles includes a decoder for decoding, for each eyepiece, one of the substreams of the given stream and having N decoding modes corresponding to the N coding modes used for coding the substreams.

### 1. CROSS-REFERENCE TO RELATED APPLICATIONS

This application is a Section 371 National Stage application of International Application No. PCT/EP2014/052067, filed Feb. 3, 2014, the content of which is incorporated herein by reference in its entirety, and published as WO 2014/118374 on Aug. 7, 2014, not in English.

### 2. FIELD OF THE INVENTION

The present invention relates to systems for viewing multimedia contents, and especially three-dimensional (3D) multimedia contents.

The invention more particularly concerns a system of viewing using viewing goggles for the simultaneous visioning of multimedia contents (or streams) through a viewing platform.

The invention can be applied especially but not exclusively to viewing systems used in immersive rooms or in museums having a plurality of heterogeneous viewing platforms designed for several users or several groups of users by means of viewing goggles. These can be educational game applications in the fields of education or museography or again professional applications such as computer-assisted design (CAD).

Here below in the description, the term “heterogeneous” refers to the fact that the viewing platforms work with distinct viewing modes such as for example “Dual-View 3D” and “Triple-View 3D”.

### 3. TECHNOLOGICAL BACKGROUND

Initially designed for stereoscopic viewing (3D viewing), liquid-crystal-based active goggles are also used for the simultaneous viewing of several multimedia contents by different users according to the technique known as the “Dual-View” technique. This technique makes it possible for example for two users to simultaneously view different multimedia contents on a same viewing platform (projection or display screen). These contents could correspond to views of a same scene from two different viewpoints or else to two different programs.

In the context of a simultaneous viewing of 2D contents by different users (“Dual-View 2D” viewing mode), the shutters of each pair of goggles are driven by a synchronization signal selected manually by the user so that he views the desired 2D content among the plurality of 2D contents proposed. Thus, for a viewing of two multimedia contents by two users for example, the shutters are used to actively separate two distinct multimedia streams and not two sub-streams of a same multimedia stream as in the case of 3D vision (i.e. a first sub-stream corresponding to a sequence of images intended for the user's right eye and a second sub-stream corresponding to a sequence of images intended for the user's left eye).

The development of increasingly complex viewing systems at present calls for the processing of a large quantity of spatially distributed multimedia streams. Since these multimedia streams have to be streamed through a large range of heterogeneous viewing platforms (projection sources associated with a display screen, television sets, computers, touch-sensitive interfaces, etc.), by using various modes of viewing, there is a real need to provide an interoperable system for the viewing of these multimedia streams.

The different viewing platforms can be distributed through the space in which the user has to move. This is the case for example during a visit to an art museum in which viewing platforms are disposed at each work of art (painting, sculpture, etc.) intended for simultaneous multiple-user viewing of the 2D or 3D multimedia streams. To facilitate the interaction of the users with the different viewing platforms (known by the term the multiple-platform interaction), each user should be capable of viewing the content diffused by a medium according to the viewing mode imposed on this platform provided that the user is looking at this medium (the user's field of view is framed in a viewing zone defined by the medium), and this must be done transparently, without action by the user on the pair of goggles or any changing of the pair of goggles itself.

There is a system, known from the patent FR2956750, of a stereoscopic vision comprising a command module for commanding active 3D goggle shutters enabling pairs of goggles to be used in three modes of operation, depending on a command signal sent out by a viewing platform: a multiplexed display mode on a same screen for different users (“Dual View 2D” mode), a 3D viewing mode and a “sunglasses” type mode. The principle of operation is as follows: the command signal is sent to the goggles so as to synchronize the “on” state of each shutter in alternation with an image that is intended for it (obtaining of a stereoscopic (3D) effect) or so as to synchronize the shutters simultaneously with a same image when the display is multiplexed between different users (obtaining a “2D Dual View” effect).

However, such a system of vision has several drawbacks. On the one hand, the pairs of active goggles work only with a limited number of viewing platforms. Indeed, since they work only in one mode of operation (active operation mode enabling an alternating switching of the shutters), such pairs of goggles are capable of adapting only to 3D and “Dual-View 2D” viewing modes. This approach cannot be applied to every medium for viewing multimedia streams, and especially to the “Dual-View 3D” and “Triple-View 3D” modes. This results in a lack of flexibility. Secondly, the passage from one mode of operation to another is done manually by the user by the activation of a switch.

It therefore seems to be particularly interesting to be able to provide a system for viewing multimedia streams comprising pairs of goggles capable of adapting automatically to the mode of viewing imposed by a given viewing platform in a multi-platform and multi-user environment.

### 4. SUMMARY OF THE INVENTION

One particular mode of the invention proposes a system for viewing N multimedia streams, with N≧2, comprising:
a plurality of pairs of viewing goggles, each pair of goggles comprising two eye-pieces,
a viewing platform,
means for obtaining N multimedia streams, each multimedia stream comprising two multimedia sub-streams among 2×N multimedia sub-streams,
N sources adapted to the generating and displaying of said 2×N multimedia sub-streams on said viewing platform, each of the two multimedia sub-streams of a same multimedia stream being associated with a distinct eye-piece among the two eye-pieces of a same pair of goggles, each source comprising encoding means adapted to encoding two of said 2×N multimedia sub-streams, each multimedia-sub-stream being encoded with a group of N encoding modes each using its own set of at least two states, having at least 2N possible combinations of states, each multimedia sub-stream being encoded with one of the possible combinations of states,
to view a given stream among said N multimedia streams, at least one pair of goggles comprising decoding means adapted to carrying out, for each eye-piece, a decoding of one of the two sub-streams of said given stream with a group of N decoding modes corresponding to the group of N encoding modes used to encode said sub-stream, and with the combination of states used to encode said sub-stream.

Thus, by associating each of the multimedia sub-streams of a same multimedia stream with a distinct eye-piece of a same pair of goggles, the invention offers a greater interoperability to a viewing system. To this end, the invention relies on the following principle:
on the source side, encoding means perform an encoding of the multimedia sub-streams with a group of N encoding modes, offering 2^{N} combinations of possible encoding states,
on the receiver side (i.e. each pair of goggles), decoding means carry out a decoding of the multimedia sub-streams with a group of N decoding modes corresponding to the group of N encoding modes used by the source or sources to encode the multimedia sub-streams, and with the combination of states used, so as to associate, with each eye-piece of the pairs of goggles, the sub-stream that is intended for it.

Thus, through this ingenious approach, the system of viewing according to the invention has increased flexibility in the management of the different modes of viewing dictated by the sources.

For example, a system for viewing N multimedia streams, with N=2 corresponding to an association of six multimedia sub-streams with six eye-pieces (or six groups of respective eye-pieces) offers the possibility of simultaneous viewing of two 3D multimedia streams by two users or two distinct groups of users (“Dual-View 3D”). With N=3 (corresponding to an association of eight multimedia sub-streams with eight eye-pieces (or eight groups of respective eye-pieces) for example, the viewing system offers the possibility of simultaneous viewing of three 3D multimedia streams by three users or three distinct groups of users (“Triple-View 3D”).

According to one particularly advantageous embodiment of the invention, in said group of encoding modes, each mode uses an own set of two states.

This particular implementation enables the encoding of each of the multimedia sub-streams to be displayed on the viewing platform with the group of N encoding modes having exactly 2N combinations of distinct states.

More particularly, the N encoding modes of said group belong to the group comprising:
a temporal encoding,
a polarization encoding,
a spectral encoding.

It must be noted that this list is not exhaustive and that other encoding modes can be implemented without departing from the context of the present invention.

According to one advantageous embodiment of the invention, the N encoding modes of said group comprise at least one passive encoding mode and at least one active encoding mode.

This embodiment requires a simple implementation of the sources but a relatively complex implementation of the pairs of goggles (the pairs of goggles must indeed be capable, for each eye-piece, of carrying out both an active decoding and a passive decoding of the multimedia sub-streams).

According to one alternative implementation of the invention, the N modes of encoding of said group comprise only passive encoding modes.

This variant enables a simple, low-cost implementation of the pairs of goggles because, for each eye-piece, they require passive decoding means. By contrast, the sources are relatively more complex to implement.

According to another variant of an implementation of the invention, the N modes of encoding of said group comprise only active encoding modes.

Advantageously, in order to view a given stream among said N multimedia streams, the system of viewing according to the invention comprises means for transmitting a configuration signal indicating, for each eye-piece, said group of N encoding modes used to encode one of the sub-streams of said given stream, and the combination of states used to encode said sub-stream, said at least one pair of goggles comprising means for receiving said configuration signal.

Thus, each pair of goggles (or group of pairs of goggles) can automatically adapt its mode of operation and implement the decoding that is appropriate to each eye-piece, according to the group of N encoding modes and the combination of states used to encode each of the sub-streams of the multimedia stream.

It is therefore possible to make the pairs of goggles self-configurable, i.e. capable of adapting the mode of operation of these goggles to the mode of viewing dictated by the sources. Thus, this pair of goggles is said to be smart in that the goggles are capable of automatically adopting the mode of viewing implemented by the sources.

According to one advantageous characteristic of the invention, each source generates two multimedia sub-streams of a same multimedia stream, associated with the two eye-pieces of a same pair of goggles.

The effect of such a characteristic it that it leads to an active mode of operation identical for each of the pairs of goggles included in the viewing system. Let us for example take a system of viewing of two multimedia streams (N=2) implementing a polarization encoding (passive encoding mode) and a temporal encoding (active encoding mode): such an embodiment gives the pairs of goggles a temporal operation that is identical (but a polarization operation that is different).

According to one alternative embodiment, said N sources comprise means of interlacing adapted to carrying out an interlacing of the 2×N multimedia sub-streams of said N multimedia streams. In other words, each source generates two multimedia sub-streams of two distinct media streams.

This alternative leads to a passive mode of operation identical for each of the pairs of goggles included in the viewing system. Let us for example take a system for viewing two multimedia streams (N=2) implementing a polarization encoding (passive encoding mode) and a sequential encoding (active encoding mode): this alternative gives the pairs of goggles an operation in polarization that is identical (but a temporal operation that is different).

The advantage of shuffling the sub-streams of the different multimedia streams by interlacing the sources is that it limits certain undesirable effects such as “ghosting”, “crosstalk” for example, which could lead to visual fatigue in users.

Another embodiment of the invention proposes a source adapted for a system for viewing of N multimedia streams, with N≧2, each multimedia stream comprising two multimedia sub-streams among 2×N multimedia sub-streams, said system comprising a plurality of pairs of viewing goggles and a viewing platform, each pair of goggles comprising two eye-pieces, said source being adapted to generating and displaying two multimedia sub-streams among said 2×N multimedia sub-streams, each of the two multimedia sub-streams of a same multimedia stream being associated with a distinct eye-piece among the two eye-pieces of a same pair of goggles. Said source is such that it comprises means of encoding adapted to encoding two of said 2×N multimedia sub-streams, each multimedia sub-stream being encoded with a group of N encoding modes each using its own set of at least two states, having at least 2^{N} combinations of possible states, each multimedia sub-stream being encoded with one of the possible combinations of states.

Thus, this particular embodiment of the invention makes it possible, by the adjoining of encoding means adapted to carrying out an encoding of each multimedia sub-stream to be displayed on the viewing platform, with a group of encoding means offering at least 2^{N} encoding combinations of possible states, to separate each of the sub-streams of a same multimedia stream so as to associate it with one of the eye-pieces of a same pair of goggles. The association of an eye-piece with a sub-stream constitutes a novel and inventive approach making it possible to offer increased flexibility in the management of the different modes of viewing of the system. The 2^{N} combinations of possible encoding states correspond to the number of eye-pieces that can be simultaneously associated with the sub-streams generated by the sources:
for N=2, six multimedia sub-streams are associated with two respective users (or two groups of users),
for N=3, eight multimedia sub-streams are associated with three respective users (or three groups of eye-pieces).

Another embodiment of the invention proposes a pair of goggles comprising two eye-pieces, adapted for a system of viewing N multimedia streams, with N≧2, each multimedia stream comprising two multimedia sub-streams among 2×N multimedia sub-streams, said system comprising a plurality of pairs of viewing goggles and a viewing platform. Since said pair of goggles comprises, for viewing a given stream among N said multimedia streams, a means of decoding adapted to performing, for each eye-piece, a decoding of one of the sub-streams of said given sub-stream with a group of N decoding modes corresponding to a group of N encoding modes to encode said sub-stream and with a combination of states used to encode said sub-stream, each encoding mode uses its own set of at least two states, said group having at least 2^{N} combinations of possible states.

Thus, this particular embodiment of the invention makes it possible to provide a pair of multi-mode goggles capable of adapting dynamically to different modes of viewing dictated by the sources (such as for example “Dual-View 3D”, “Triple-View 3D” for example). To this end, the invention relies on the adjoining of a decoding mode based, for each eye-piece, to a group of decoding modes corresponding to the counterpart of the group of N encoding modes and to the counterpart of the combination of states used to encode the sub-stream for which the eye-piece is intended.

### 5. LIST OF FIGURES

Other features and advantages of the invention shall appear from the following description, given by way of an indicative and non-exhaustive example and from the appended figures, of which:

FIG. 1 is a block diagram of a system of viewing according to one particular embodiment of the invention;

FIG. 2 is a view in the form of a functional block diagram, of the structure of a system of viewing comprising a viewing platform and two pairs of viewing goggles according to one particular embodiment of the invention;

FIG. 3 is a schematic diagram illustrating the operation of the means of encoding and decoding of the system of viewing of FIG. 1 according to a first alternative embodiment;

FIG. 4 is a schematic diagram illustrating the operation of the means of encoding and decoding of the system of viewing of FIG. 1 according to a second alternative embodiment;

FIG. 5 is an example of an encoding table used in the context of the first alternative embodiment described in FIG. 3.

### 6. DETAILED DESCRIPTION

In all the figures of the present document, the identical elements and steps are designated by a same numerical reference.

To view a given stream among N multimedia streams generated and displayed on a viewing platform (with N≧2), the invention relies on an encoding, called a source encoding, of the sub-streams of the multimedia streams with a group of N encoding modes having at least 2^{N} combinations of possible states, each multimedia sub-stream being encoded with one of the possible combinations of states, and a decoding, on the receiver side (i.e. on the side corresponding to the pairs of goggles), of each of the encoded sub-streams of the given stream with a group of N decoding modes corresponding to the counterpart of the pair of the N encoding modes and the combination of states used to encode the sub-streams. More particularly, the invention relates to a system of viewing having means available for encoding at the sources and means for decoding at the pairs of viewing goggles, that respectively implement an encoding and a decoding of the multimedia sub-streams based on a combination of encoding states following a combinatorial scheme in terms of power of 2, enabling the association of each of the sub-streams of a same multimedia stream with a distinct eye-piece of a same pair of goggles. This principle offers increased flexibility in the management of the modes of viewing implemented by the viewing platforms; the pairs of goggles are indeed made interoperable with a greater number of viewing platforms working according to different viewing modes. Unlike the prior-art solutions in which the pairs of goggles work only with a limited number of viewing platforms, those of the present invention are capable of adapting to numerous modes of 3D viewing.

The number N is a natural integer, greater than or equal to 2, that designates the number of encoding modes implemented simultaneously by the encoding means. It also designates the number of decoding modes implemented simultaneously by the decoding means so as to associate one of the sub-streams of a same multimedia stream with a distinct eye-piece of a same pair of goggles. Each group of N encoding modes offers at least 2^{N} distinct combinations of encoding states, which means that the maximum number of eye-pieces (or eye-piece channels) that can be addressed simultaneously is equal to 2^{N}.

The term “encoding mode” is understood to mean the operation in which a multimedia stream or a sub-stream is encoded by means of one of the following encoding methods:
sequential encoding (or temporal encoding), denoted as C1 here below;
polarization encoding (or modal encoding), denoted as C2 here below;
spectral encoding (or anaglyphic encoding), denoted as C3 here below.

The sequential encoding (C1) relies on the sending of multimedia sub-streams alternated in the time domain: an image intended for the right eye and an image intended for the left eye. The use of optical shutters on each pair of goggles enables the two ocular channels to be separated, i.e. it enables the association of each of the two sub-streams of a same multimedia stream with the eye-piece that is intended for it. The number of ocular channels that can be separated in temporal encoding is not limited in theory. It is enough to increase the frequency of emission of the images according to the number of ocular channels desired. It will be noted that in practice the power of the ocular channel related to the power of the source diminishes especially to the extent that the number of ocular channels considered is high.

Polarization encoding (C2) enables a separation of the multimedia sub-streams by using orthogonal polarizer filters. The polarizer filters applied to the goggle glasses can be selected from among the crossed linear polarizers or left and right circular polarizers. Since the orthogonal polarization states are limited to two, the polarization encoding does not enable the separation of more than two ocular channels.

Spectral encoding (C3) enables a separation of the multimedia sub-streams by using interference filters. Triplets of narrow-band colored filters distribute two offset trichromatic syntheses in order to separate at least two ocular channels. From a practical viewpoint, the difficulty of achieving this result arises out of the need to use light sources having very fine spectral bands as well as highly selective interference filters.

Depending on the value of the number N, the viewing system according to the invention can implement different embodiments:
the viewing mode corresponding to N=2 is the dual 3D mode (simultaneous viewing of two distinct 3D multimedia streams by two users or two distinct groups of users, also called “Dual-View 3D” mode),
the viewing mode corresponding to N=3 is the Triple 3D mode (simultaneous viewing of distinct 3D multimedia streams by three users or three distinct groups of users, also called “Triple-View 3D” mode),
etc.

It must be noted that the number of users is not limited to the number N, but N refers to the fact that N different multimedia streams are available at the same time.

Here below in the description, the number N of encoding modes implemented shall be considered to be equal to 2 and the number of possible combinations of states to 4 (2²). This number is deliberately limited in order to simplify the description. It is clear that a greater number of encoding modes and/or combinations of states can be implemented without departing from the framework of the invention.

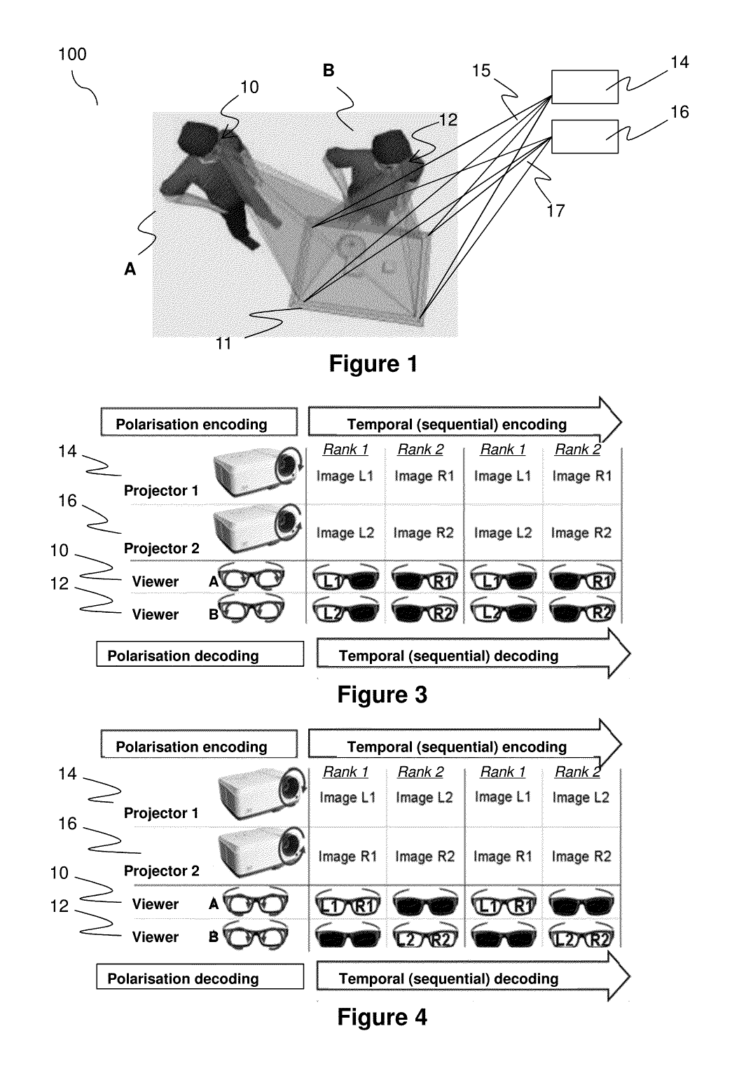

Referring now to FIG. 1, we present an example of a viewing system 100 according to one particular embodiment of the invention. This is a system of viewing 100 comprising a viewing platform and two pairs of viewing goggles (10, 12). A first pair of goggles 10 is worn by a first user A and a second pair of goggles is worn by a second user B. The viewing platform is formed here by a display screen 11 and two sources 14 and 16 adapted to generating and simultaneously projecting two multimedia streams 15 and 17 on the display screen. It can for example be the projection of two video contents in three dimensions (3D), the first being intended for the user A and the second for the user B.

In general, a display medium can be likened to a monobloc device comprising a projection screen and a plurality of sources (for example a television set, a touch-sensitive tablet or a device that is not a monobloc unit and comprises two separate elements as is the case in FIG. 1, a display screen associated with a plurality of projection sources. Here below, no distinction shall be made between the display screen and the viewing platform.

In this particular embodiment, the viewing system 100 is configured so that the number N is equal to 2, thus enabling an operation in dual view 3D mode, in other words a simultaneous viewing by two users (or two groups of users) of two distinct 3D multimedia streams:
a first multimedia stream 15 comprising two sub-streams;
   a first sub-stream corresponding to a sequence of images (denoted as “R1”) intended for the right eye of the first user A (or a first group of users A),
   a second sub-stream corresponding to a sequence of images (denoted as “L1”) intended for the left eye of the first user A (or of the first group of users A),
a second multimedia stream 17 comprising two sub-streams:
   a first sub-stream corresponding to a sequence of images (denoted as “R2”) intended for the right eye of the second user B (or of the second group of users B),
   a second sub-stream corresponding to a sequence of images (denoted as “L2”) intended for the left eye of the second user B (or of the first group of users B.

FIG. 2 is a representation, in the form of functional blocks, of the structure of a viewing system according to the particular embodiment of the invention in which N=2. The viewing system more particularly comprises two sources 314, 316 and two pairs of goggles 310, 312.

It is considered here that the pairs of goggles 310 and 312 respectively work with the sources 314 and 316.

The source 314 comprises:
means for obtaining (denoted as MdO) 301 responsible for providing two multimedia sub-streams F1 and F2 of a same multimedia stream, the two multimedia sub-streams F1 and F2 being associated respectively with the eye-pieces O1 and O2 of the pair of goggles 310,
means for encoding (denoted as MdC) 303 each responsible for providing two sub-streams F1 and F2 with a group of two encoding modes (among the encoding modes C1, C2, C3 for example) and with one of the four combinations of encoding states possible, according to the principle of implementation of the invention (this principle being described in more ample detail here below with reference to FIGS. 3 and 4), and each responsible for generating and displaying the two sub-streams F1′ and F2′ thus encoded on the display screen 311,
means of generation (denoted as MdG) 305 for generating a configuration signal 315 intended for the pair of goggles which has been “locked” to the source 314, the configuration signal 315 comprising:
   a field for identifying the display screen (Eₕ);
   a mode-indicating field (Mₖ) intended for indicating the group of encoding modes and the combination of encoding states used to encode each of the sub-streams F1 and F2;
   a field for identifying a stream (Fⱼ) intended for indicating the eye-pieces O1 and O2 with which the sub-streams F1 and F2 are respectively associated;
an input/output interface block (denoted as I/O If for “Input/Output Interface”) 307 is used to form an interface with the pairs of goggles 310, 312 using for example a radiofrequency communications protocol (RF) or infrared (IR) communications protocol.

The source 316 comprises:
means for obtaining (denoted as MdO) 302 responsible for providing two multimedia sub-streams F3 and F4 of a same multimedia stream, the two multimedia sub-streams F3 and F4 being associated respectively with the eye-pieces O3 and O4 of the pair of goggles 312,
means for encoding (denoted as MdC) 304 responsible for encoding the two sub-streams F3 and F4 with a group of two encoding modes (among the encoding modes C1, C2, C3 for example) and with one of the four combinations of encoding states possible, according to the principle of implementation of the invention (this principle being described in more ample detail with reference to FIGS. 3 and 4) and responsible for generating and displaying the sub-streams F3′ and F4′ thus encoded on the display screen 311,
means of generation (denoted as MdG) 306 for generating a configuration signal 317 intended for the pair of goggles being “locked” into the source 316, the configuration signal 317 comprising:
   a field for identifying the display screen (Eₕ);
   a mode-indicating field (Mₖ) intended for indicating the group of encoding modes and the combination of encoding states used to encode each of the sub-streams F3 and F4;
   a stream-identification field (Fⱼ) intended the eye-pieces O3 and O4 with which the sub-streams F3 and F4 are respectively associated;
an input/output interface block (denoted as I/O If for “Input/Output Interface”) 308 enabling the interface to be set up with the pairs of goggles 310, 312 using for example a radiofrequency communications protocol (RF) or infrared (IR) communications protocol.

The pair of goggles 310 comprises:
an input/output interface block (denoted as I/O If) 321 used to set up an interface of the sources 314, 316 using for example the communications protocol IRdA and intended to receive the configuration signal from the source to which the pair of goggles 310 is locked,
extraction means (denoted as MdE) 323 for extracting configuration information (triplet (Eₕ, Fⱼ, Mₖ)) contained in the configuration signal 315 received by the I/O block If 231, used to configure the pair of goggles according to the encoding made at the sources 14 and 16,
means of decoding (denoted as MdD) 325 carrying out a decoding for each eye-piece O1 and O2 of one of the two sub-streams F1′ and F2′ with a group of decoding modes that depends on all the encoding modes and the combination of encoding states that have been used to encode the sub-streams F1 or F2 and which are derived from configuration information extracted by the means 323,
a command block (denoted as MdCO) 327 for the shutters O1 and O2 activated by the decoding means to enable the synchronization of the “on” state of each shutter O1 and O2 alternately or simultaneously to view the sub-stream F1 or F2 that is intended for it depending on all the decoding modes applied.

The pair of goggles 312 comprises:
an input/output interface block (denoted as I/O If) 322 used to set up an interface of the sources 314, 316 using for example the communications protocol IRdA and intended to receive the configuration signal from the source to which the pair of goggles 312 is locked,
extraction means (denoted as MdE) 324 for extracting configuration information (triplet (Eₕ, Fⱼ, Mₖ)) contained in the configuration signal 317 received by the I/O block If 231, used to configure the pair of goggles according to the encoding made at the sources 14 and 16,
means of decoding (denoted as MdD) 326 carrying out a decoding for each eye-piece O3 and O4 of one of the two sub-streams F3′ and F4′ with a group of decoding modes that depends on all the encoding modes and the combination of encoding states that have been used to encode the sub-streams F3 or F4 and which are derived from configuration information extracted by the means 324,
a command block (denoted as MdCO) 328 for the shutters O3 and O4 activated by the decoding means to enable the synchronization of the “on” state of each shutter O3 and O4 alternately or simultaneously to view the sub-stream F3 or F4 that is intended for it depending on all the decoding modes applied.

As discussed further above, the pairs of goggles 310 and 312 are synchronized respectively with the sources 314 and 316. To this end, a selection protocol for selecting a given stream among the two multimedia streams is preliminarily implemented. This protocol can be activated manually by the user in choosing the desired multimedia stream by means of a switch for example (choice of a frequency at which the multimedia stream is generated). According to one alternative embodiment, the selection protocol can be activated automatically by detecting the user's field of vision in a predefined viewing zone predefined by the viewing platform.

Besides, the configuration signals 315 and 317 can furthermore classically undergo an encryption by means of an encryption key. In this case, the pairs of goggles must be provided with means for carrying out the decryption of the configuration signal that has been sent to it by the interface block 321 and 322.

FIG. 3 is a schematic drawing illustrating the operation of the encoding and decoding means of the viewing system 100 according to a first alternative embodiment.

The source 14 (projector 1) is configured so as to generate and project a sequence of images L1 and a sequence of images R1 of a first multimedia stream 15 on the display screen 11 according to a first polarization state while the source 16 (projector 2) is configured so as to generate and project a sequence of images L2 and a sequence of images R2 of a second multimedia stream 17 on the display screen 11 according to a second polarization state. It may be recalled that the multimedia stream 15 is intended for the user A (pair of goggles 10) and the multimedia stream 17 is intended for the user B (pair of goggles 12). To this end, the source 14 comprises a first polarizer which acts on the images L1 and R1 generated so as to obtain right circularly polarized images while the source 16 comprises a second polarizer that acts on the images L2 and R2 generated so as to obtain left circularly polarized images. These polarizers constitute the means of polarization encoding making it possible to implement a mode of polarization encoding (C2) with two states: right polarization encoding (first encoding state) and left polarization encoding (second encoding state).

The source 14 also comprises sequential encoding means provided to alternately send out a first page (L1) of a first sequence of images intended for the user's left eye (eye-piece O1 of the pair of goggles 10) and a second image (R1) of a second sequence of images intended for the user's right eye (eye-piece O2 of the pair of goggles 10). Similarly, the source 16 comprises sequential encoding means designed to alternately send out a first image (L2) of a third sequence of images intended for the user's left eye B (left eye-piece O3 of the pair of goggles 12) and a second image (R2) of a fourth sequence of images intended for the user's right eye (eye-piece O4 of the pair of goggles 12). These means of sequential encoding make it possible to implement sequential encoding mode (C1) with two states: assigning the first image L1 or L2 to the rank 1 (first encoding state) and assigning the second image R1 or R2 to the rank 2 (second encoding image).

In short, the images L1 are right circularly polarized and assigned to the rank 1, the images R1 are right circularly polarized and assigned to the rank 2, the images L2 are left circularly polarized and assigned to the rank 1, the images R2 are left circularly polarized and assigned to the rank 2. Such an encoding of the images thus enables a possible association of four distinct images (L1, R1, L2, R2) with four distinct ocular channels.

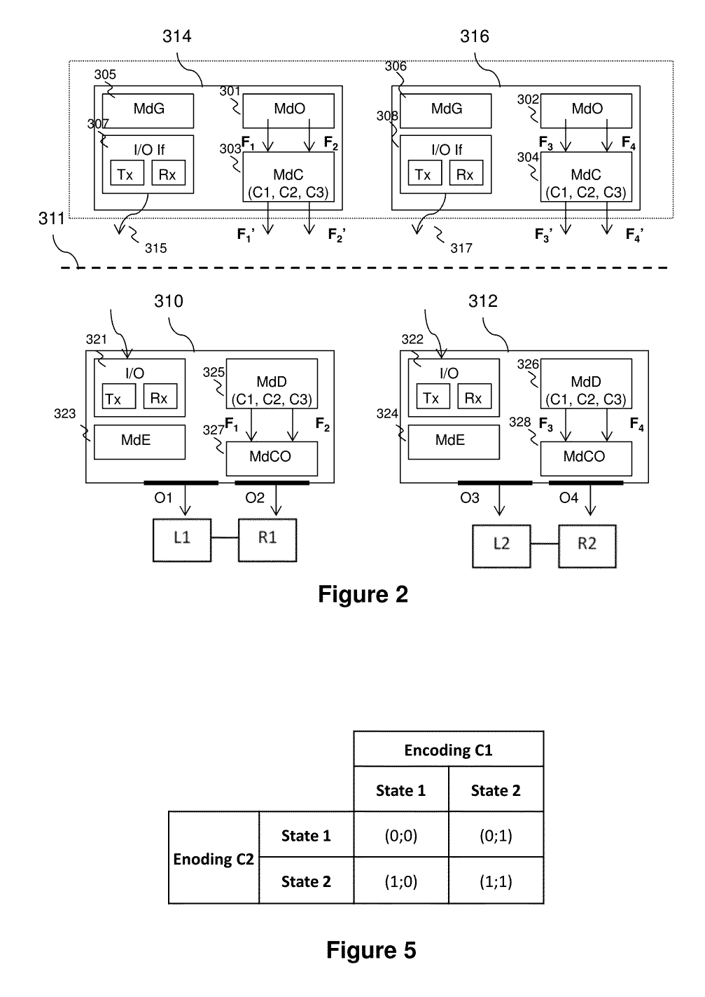

The information on the encoding modes and the combination of states used to encode each multimedia sub-stream at each of the sources 14 and 16 can be stored in the form of and encoding table as illustrated for example in FIG. 5.

In the embodiment described here, each multimedia sub-stream is encoded with a group of two encoding modes: a sequential encoding (denoted as C1) and a polarization encoding (denoted as C2). Each encoding mode uses an own set of two states (allocated the FIG. 0 or 1). The encoding table thus makes it possible to store the group of two encoding modes used to encode the multimedia sub-stream considered, as well as the set of states (or combination of states) used to encode the multimedia sub-stream considered.

For the encoding C1 for example, “0” is assigned to an encoding of the sub-stream considered by right circular polarization and “1” to an encoding by left circular polarization. For the encoding C2 for example, “0” is assigned to an encoding of the sub-stream considered to the rank 1 and the “1” for an assigning to the rank 2. For example, the set of states (0; 1) signifies that the sub-stream has been encoded with a right polarization state and an assigning to the rank 2 (which corresponds to the sequence of images R1 in the example of FIG. 3).

With each encoding table, there is therefore associated a multimedia sub-stream. This encoding table can be stored in the mode-indicating field (Mₖ) of the configuration signal emitted by the source. The stream-identifying field (Fⱼ) indicates which sub-stream is associated with this encoding table and which eye-piece (right eye or left eye) is associated with this sub-stream. In this way, when the pair of goggles receives the configuration signal in extracting the configuration information stored therein, the pair of goggles can consult the encoding table to determine the group of two encoding modes as well as the set of states (or combination of states) used to encode the multimedia sub-streams with which said table is associated, and therefore deduce the group of two decoding modes and the combinations of states to be used to decode said sub-stream.

The polarization decoding of the multimedia sub-streams at a pair of goggles is done through the use of polarizers which make it possible to obtain glasses polarized in to two distinct polarization states: right circular polarization or left circular polarization. These polarizers constitute means of optical polarization decoding and enable a discrimination of the multimedia sub-streams at the level of the eye-pieces of the pairs of goggles according to their polarization state. To this end, the pair of goggles 10 of the user A has glasses polarized according to a right circular polarization state while the pair of goggles 12 of the user A has glasses polarized according to a left circular polarization state.

The sequential decoding of the multimedia sub-streams at a pair of goggles is done through the use of shutters (active glasses constituted for example by liquid-crystal cells). Each eye-piece is associated with a shutter which has two distinct states: an on state and an off state. These shutters constitute sequential decoding means. They enable a discrimination of the multimedia sub-streams at the eye-pieces of the pair of goggles according to a temporal rank that had been assigned to them at the sources. As described further above with reference to FIG. 2, a control block takes charge of activating or deactivating the shutters to put them in the on state or else in the off state depending on the set of states described in the encoding table and in a synchronized way with the sources 14 and 16 through the configuration signal. The shutters are driven by a polarization signal defined and designed to optimize the temporal response and optical response of the shutters according to the technology of their manufacture and the speed of sequencing of the sub-stream of images. This polarization signal is produced by the command block as a function of the configuration signal received by the pair of goggles to temporally separate the two sub-streams of images (L1, R1 or L2, R2) which are intended for it. The encoding table contained in the configuration signal conditions the order of temporal sequencing of the sub-streams of images so that each pair of goggles can get synchronized with the two sub-streams intended for it. In other words, the configuration signal is sent to the pair of goggles so as to synchronize the on or off state of each shutter alternately or simultaneously with an image intended for it, depending on the set of states described in the encoding table.

During a first time slot T₁, the images L1 and L2 are simultaneously sent out by the sources 14 and 16 respectively according to orthogonal circular polarization states. During this time slot T₀, the two pairs of goggles 10 and 12 are driven simultaneously so that the shutter corresponding to the right eye is activated (off state) and the shutter corresponding to the left eye is deactivated (on state) so as not to let through the image intended for the left eye (L1 or L2). During a second time slot T₂, the right-hand images R1 and R2 are simultaneously sent out by the sources 14 and 16 respectively and the pairs of goggles 10, 12 are driven simultaneously so that the shutter corresponding to the left eye is active (off state) and the shutter corresponding to the right eye is deactivated (on state) so as to let through only the image intended for the right eye (R1 or R2). Thus, each user perceives only the two sub-streams of images which are his own (L1, R1 or L2, R2) according to a given polarization state and with an alternating shuttering of the active glasses to enable stereoscopic viewing of the 3D stream displayed in FIG. 11.

This alternative embodiment described in FIG. 3 dictates a different optical configuration of the pairs of goggles and an identical sequential configuration (viewing in alternating operation).

Referring now to FIG. 4, we briefly present the working of the encoding means and the decoding means of the viewing system 100 according to a second embodiment.

This alternative variant dictates an identical optical configuration of the pairs of goggles and a different sequential configuration (viewing in simultaneous operation).

The operation of the encoding means of FIG. 4 differs from that of FIG. 3 in that the sources 14 and 16 are configured so as to obtain an interlacing (or shuffling) of the sub-streams of images (L1, L2, R1, R2) intended for both users. To this end, the sources 14 and 16 comprise, upstream to the encoding means 303 and 304, a common block (not illustrated in the figures) intended to obtain an interlacing of the four images L1, R1, L2, R2 as follows: the images L1 and L2 are intended for display by the source 14 and the images R1 and R2 are intended for display by the source 16.

The source 14 sends out the “left” images L1 and L2 intended for the left eye of the users A and B respectively, in alternation, these images having a state of right circular polarization while the source 16 sends out, in alternation, the “right” images R1 and R2 intended respectively for the right eye of the users A and B, these images having a left circular polarization. As in the case of the variant described in FIG. 3, the assigning of each image to a polarization state is achieved by means of polarization encoding means (polarizers) and the assigning of each image to a given rank in the sequence of images is obtained by means of a sequential encoding means.

Besides, the two pairs of goggles 10 and 11 are identical and each of them has a first glass polarized according to a right circular polarization state and a second glass polarized according to a left circular polarization state.

During a first time slot T₁, a left-hand image (L1) intended for the left eye of the user A and a right-hand image (R1) intended for the right eye of the user A are simultaneously sent out by the sources 14 and 16 respectively. During this time slot T₁, both pairs of goggles 10 and 12 are driven so that the two active glasses of the first pair of goggles 10 are placed in an on state to enable the user A to view both images that are intended for him (namely L1 and R1) while the two active glasses of the second pair of goggles 12 are placed in an off state to prevent the user from viewing the images intended for the other user A. The effect of a stereoscopic vision is obtained by the fact that the right-hand image (R1) and the left-hand image (L1) viewed simultaneously are separated at the first pair of goggles 10. To this end, the two active glasses of each pair of goggles 10 and 12 are polarized respectively according to two states of orthogonal polarization. This second variant has the advantage in which all the pairs of glasses used in a same system of viewing are, from an optical point of view, physically identical.

It must be noted that this second alternative embodiment imposes a situation where the four sub-streams of the two multimedia streams are projected on the same plane (marked out on a common display zone), which is not necessary in the first variant (FIG. 3). The main advantage of shuffling the sub-streams of different multimedia streams in interlacing the sources is that it limits certain undesirable effects such as “ghosting”, “crosstalk” or again the imbalance between the intensities and/or colors of two sources, these effects having the drawback of generating visual fatigue for users. Thus, by using two interlaced sources, it is possible to more finely adjust the light and colorimetrical balance of the multimedia streams.

In the two alternative embodiments described here above with reference to FIGS. 3 and 4, the use of pairs of goggles combines two modes of operation: an “active” mode characterized by an alternate shuttering of the active glasses of the goggles and a “passive” mode characterized by a selection in polarization. It was therefore considered in these two variants that the means for polarization decoding were not reconfigurable and enabled use according to a “passive” decoding mode for passive selection of the sub-stream of images according to their state of polarization. In this particular case, it therefore does not appear to be necessary to store the encoding state with which the sub-stream of images has been encoded in an encoding table (the right-hand or left-hand polarization state), since these passive decoding means are naturally capable of carrying out the decoding without requesting an active command of the pair of goggles. Only the information on configuration pertaining to the sequential encoding can be transmitted to the pairs of goggles so that they each adapt their own system of shuttering of the eye-pieces.

It is possible however to envisage a variant of implementation according to the invention for integrating an optical cell in each pair of goggles and at each optical glass, the polarization state of this cell being dynamically configurable. In this case, the decoding means enable use according to an “active” decoding mode. This type of optical glass nevertheless is still costly and relatively complex to implement and makes it less comfortable to wear goggles.

The viewing system described here above is intended for operation in 3D dual view mode (N=2) (in other words, a simultaneous viewing by two users (or groups of users) of two distinct 3D multimedia streams), based on an encoding of a multimedia sub-streams with a group of two distinct encoding modes: a sequential mode and a mode by polarization. It is clear that many other embodiments of the invention can be envisaged without departing from the framework of the invention. It is possible especially to plan for other possible encoding combinations such as those indicated in the table below for the case where N=2:

| | | First encoding mode | | |
|---|---|---|---|---|
| | | | Polarization | Spectral |
| | | Sequential | encoding | encoding |
| | | encoding (C1) | (C2) | (C3) |
| Second | Sequential | Yes | Yes | Yes |
| encoding | encoding | | (variant of | |
| mode | (C1) | | FIG. 4) | |
| | Polarization | Yes | — | Yes |
| | encoding | (variant of | | |
| | (C2) | FIG. 3) | | |
| | Spectral | Yes | Yes | Yes |
| | encoding | | | |
| | (C3) | | | |

An embodiment of the present disclosure provides a system of viewing with increased interoperability.

An embodiment provides a system of viewing that is simple and costs little to implement.

An embodiment provides a pair of multi-mode goggles capable of adapting dynamically to the mode of viewing dictated by a given viewing platform.

Although the present disclosure has been described with reference to one or more examples, workers skilled in the art will recognize that changes may be made in form and detail without departing from the scope of the disclosure and/or the appended claims.

1. A system for viewing N multimedia streams, with N≧2, comprising:
a plurality of pairs of viewing goggles, each pair of goggles comprising two eye-pieces;
a viewing platform;
means for obtaining N multimedia streams, each multimedia stream comprising two multimedia sub-streams among 2×N multimedia sub-streams;
N sources adapted to generate and display said 2×N multimedia sub-streams on said viewing platform, each of the two multimedia sub-streams of a same multimedia stream being associated with a distinct eye-piece among the two eye-pieces of a same pair of goggles, each source comprising an encoder configured to encode two of said 2×N multimedia sub-streams, each multimedia sub-stream being encoded with a group of N encoding modes each using an own set of at least two states, having at least 2^{N} possible combinations of states, each multimedia sub-stream being encoded with one of the possible combinations of states,
wherein at least one pair of the goggles comprises, to view a given stream among said N multimedia streams, a decoder configured to carry out, for each eye-piece, a decoding of one of the two sub-streams of said given stream with a group of N decoding modes corresponding to the group of N encoding modes used to encode said sub-stream, and with the combination of states used to encode said sub-stream.

2. The system for viewing according to claim 1 wherein said group of N encoding modes use each mode uses an own set of two states.

3. The system for viewing according to claim 1, wherein the N encoding modes of said group belong to the group consisting of:
a temporal encoding,
a polarization encoding,
a spectral encoding.

4. The system for viewing according to claim 1, wherein the N encoding modes of said group comprise at least one passive encoding mode and at least one active encoding mode.

5. The system for viewing according to claim 1, wherein the N modes of encoding of said group comprise only passive encoding modes.

6. The system for viewing according to claim 1, wherein the N modes of encoding of said group comprise only active encoding modes.

7. The system for viewing according to claim 1, comprising, to view a given stream among said N multimedia streams, means for transmitting a configuration signal indicating, for each eye-piece, said group of the N encoding modes used to encode one of the sub-streams of said given stream, and the combination of states used to encode said sub-stream,
and wherein said at least one pair of the goggles comprises means for receiving said configuration signal.

8. The system for viewing according to claim 1, wherein each source generates two multimedia sub-streams of a same multimedia stream, associated with the two eye-pieces of a same pair of the goggles.

9. The system for viewing according to claim 1, wherein said N sources comprise an interlacer configured to carry out an interlacing of the 2×N multimedia sub-streams of said N multimedia streams.

10. A source adapted for a system for viewing N multimedia streams, with N≧2, and furthermore comprising a plurality of pairs of viewing goggles and a viewing platform, each multimedia stream comprising two multimedia sub-streams among said 2×N multimedia sub-streams, said source being adapted to generate and display two multimedia sub-streams among said 2×N multimedia sub-streams on said viewing platform, each of the two multimedia sub-streams of a same multimedia stream being associated with a distinct eye-piece among the two eye-pieces of a same pair of goggles, wherein said source comprises:
an encoder configured to encode two of said 2×N multimedia sub-streams, each multimedia sub-stream being encoded with a group of N encoding modes each using an own set of at least two states, having at least 2^{N} possible combinations of states, each multimedia sub-stream being encoded with one of the possible combinations of states.

11. A pair of goggles adapted for a system for viewing N multimedia streams, with N≧2, and furthermore comprising a plurality of pairs of viewing goggles and a viewing platform, each multimedia stream comprising two multimedia sub-streams among said 2×N multimedia sub-streams, said pair of goggles comprising:
two eye-pieces; and
a decoder configured to carry out, for each eye-piece, a decoding of one of the sub-streams of said given stream with a group of N decoding modes corresponding to a group of N encoding modes used to encode said sub-stream and with a combination of states used to encode said sub-stream, each encoding mode using a own set of at least two states, said group having at least 2^{N} possible combinations of states, wherein the decoding enables viewing a given stream among said multimedia streams on said viewing platform.
